(19) United States
(12) Patent Application Publication
(10) Pub. No.: US 2019/0205617 A1
(43) Pub. Date: Jul. 4, 2019

(54) SYSTEM AND METHOD FOR COMBINING IDENTITY INFORMATION TO FACILITATE IMAGE ACQUISITION

(71) Applicant: Idemia Identity & Security USA LLC, Billerica, MA (US)

(72) Inventors: Brian Bertan, Merrick, NY (US); Brian K. Martin, McMurray, PA (US)

(21) Appl. No.: 16/236,895

(22) Filed: Dec. 31, 2018

Related U.S. Application Data
(60) Provisional application No. 62/612,047, filed on Dec. 29, 2017.

(51) Int. Cl. G06K 9/00; G06K 9/20; G06K 9/03

(52) U.S. Cl. CPC G06K 9/00255; G06K 9/00268; G06K 9/209; G06K 2209/01; G06K 9/00442; G06K 2209/27; G06K 9/036

(57) ABSTRACT

Methods, systems, and apparatus, including computer programs encoded on a computer storage medium, for combining identify information to facilitate image acquisition are disclosed. In one aspect, a method includes the actions of receiving, by one or more computers, an image that includes a representation of a face of an individual. The actions further include receiving, by the one or more computers, data identifying characteristics of the individual. The actions further include based on the characteristics of the person, adjusting, by the one or more computers, facial detection parameters. The actions further include performing, by the one or more computers, facial detection on the image using the adjusted facial detection parameters.

### CROSS-REFERENCE TO RELATED APPLICATION

This application claims the benefit of U.S. Application No. 62/612,047, filed on Dec. 29, 2017, which is incorporated by reference.

### TECHNICAL FIELD

This document generally relates improving the acquisition of biometric images such as facial portraits.

### BACKGROUND

Biometric images such as facial portraits are routinely captured from human subjects for identity verification and enrollment.

### SUMMARY

Applications of biometric identification usually include the use of facial portraits, finger-prints, palm-prints, and others. Such identification using biometric images may cope with variations in a subject's age and gender as well as limitations in facilities where the biometric images were taken. In many applications using face detection, demographic data specifying a group of subjects and biometric information (or individual information) specific to the subject may be available prior to face detection. Examples of demographic data may include age, gender, race, and ethnicity. Examples of biometric data specific to the subject may include height, weight, hair color, and eye color. Some implementations may leverage such information to optimize and improve the image acquisition process. For example, when a subject is older than a particular age, the acquisition of a facial portrait may assume certain eyewear, which implicates the modules fine-tuned for reducing glaring reflections from eyewear that may otherwise negatively impact image acquisition quality. When a subject is of a particular gender, image acquisition modules may include functions particularly suited for handling hairstyles commonly seen for this particular gender. When a subject is of a race with a particular skin color, the image acquisition module may be conditioned to adjust illumination and exposure parameters such that photo portraits can come out with sharper contrast than otherwise would be the case. What is more, the combination of demographic data and biometric data may buttress features automatically extracted from the biometric image so that the registration entity can have improved confidence in the biometric image taken at the registration site.

The disclosure focuses on system and method to leverage inter-group variations as revealed from the demographic data as well as individual specific information as inferred from the biometric data to improve the acquisition quality of subsequently taken biometric images.

According to an innovative aspect of the subject matter described in this application, a method for combining identify information to facilitate image acquisition includes the actions of receiving, by one or more computers, an image that includes a representation of a face of an individual; receiving, by the one or more computers, data identifying characteristics of the individual; based on the characteristics of the person, adjusting, by the one or more computers, facial detection parameters; and performing, by the one or more computers, facial detection on the image using the adjusted facial detection parameters.

These and other implementations can each optionally include one or more of the following features. The actions further include, based on the characteristics of the person, adjusting, by the one or more computers, the image. The action of performing facial detection on the image using the adjusted facial detection parameters includes performing facial detection on the adjusted image using the adjusted facial detection parameters. The action of receiving data identifying characteristics of the individual includes receiving demographic data of the individual; and receiving biometric data of the individual. The action of adjusting facial detection parameters includes identifying likely facial characteristics of the individual based on the characteristics of the person. The actions further include, based on the characteristics of the person, adjusting, by the one or more computers, parameters of a camera that captured the image; receiving, by the one or more computers, an additional image that includes an additional representation of the face of the individual and that was captured by the camera with the adjusted parameters; and performing, by the one or more computers, facial detection on the additional image using the adjusted facial detection parameters.

The actions further include, based on performing facial detection on the image, determining, by the one or more computers, that the image includes a representation of a face; determining, by the one or more computers, a value that reflects a quality of the representation of the face; comparing, by the one or more computers, the value that reflects the quality of the representation of the face to a threshold value for a system receiving the image; determining, by the one or more computers, that the value that reflects the quality of the representation of the face satisfies the threshold value for the system receiving the image; and, based on determining that the value that reflects the quality of the representation of the face satisfies the threshold value for the system receiving the image, providing, by the one or more computer, the image to the system. The action of receiving data identifying characteristics of the individual includes performing optical character recognition on a personal identification document of the individual.

Other implementations of this aspect include corresponding systems, apparatus, and computer programs recorded on computer storage devices, each configured to perform the operations of the methods.

Particular implementations of the subject matter described in this specification can be implemented so as to realize one or more of the following advantages. The image capture system may use less processing power to perform facial detection when the facial detection parameters are biased toward likely features of the subject.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for combining identity information to improve facial detection.

FIG. 2 is a diagram showing an example of combining information including demographic information and individual specific information to improve the quality and confidence of acquired biometric images.

FIG. 3 is a flowchart of an example process for using identity information to improve facial detection.

FIG. 4 is an example of a computing device and a mobile computing device.

Like reference numbers and designations in the various drawings indicate like elements.

### DETAILED DESCRIPTION

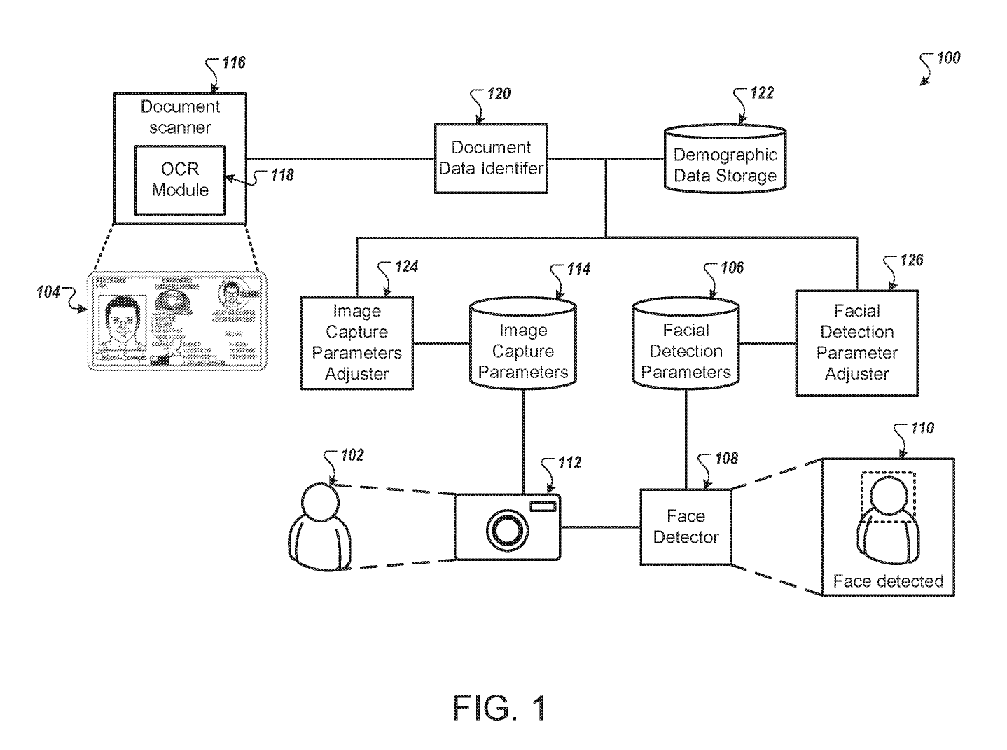

FIG. 1 illustrates an example system 100 for combining identity information to improve facial detection. Briefly, and as described in more detail below, the system 100 captures an image 110 of the user 102. The system 100 accesses data extracted from an identification document 104 and demographic information of the user 102 to adjust facial detection parameters. The face detector 108 uses the adjusted facial detection parameters to perform facial detection on the image 110. In some implementations, the system 100 performs facial detection to ensure the image 110 is of satisfactory quality for use by an application or for enrollment in a service.

In more detail, the system 100 includes a camera 112 that captures an image 110 of the user 102. In some implementations, the user 102 may not provide information to the camera 112 to indicate that the user 102 or any other person is within the field of view of the camera 112. The camera 112 may be configured to perform facial detection on the image 110 to determine whether the image 110 includes a face. In some implementations, the camera 112 or another component of the system 100 may be configured to perform facial recognition on the image 110 in addition to the facial detection.

The camera 112 may use the image capture parameters 114 to capture the image 110. The image capture parameters 114 may include parameters for image brightness, contrast, sharpness, saturation, filter type, exposure, flash, and any other similar image capture parameters. The image capture parameters 114 may be preset to a default setting that is configured to capture an image on which the face detector 108 typically performs more accurate facial detection than with other settings. The face detector 108 may be able to perform facial detection with ninety percent accuracy on a sample group of images captured with the image capture parameters at the default settings. The sample group of images may include faces from a diverse group of individuals instead of only from individuals who are, for example, older than sixty. In some implementations, the face detector 108 may perform facial detection with eighty percent accuracy on a sample group of images that only includes individuals who are older than sixty and captured with the image capture parameters at the default settings. In this instance, it may be advantageous to adjust the image capture parameters if the system 100 is able to access information that any subject of the image is likely to be older than sixty.

Similarly, the face detector 108 may use facial detection parameters 106 to perform facial recognition on the image 110. The facial detection parameters 106 may include various coefficients of a model used to perform facial detection. The facial detection parameters 106 may also include various parameters used for edge detection, facial feature detection such as eye, mouth, nose, and/or ear detection, and any other similar facial detection parameters.

The facial detection parameters 106 may be preset to a default setting that is configured to perform facial detection on an image more accurately than with other settings. The face detector 108 may be able to perform facial detection with ninety percent accuracy on a sample group of images using the default facial detection parameters. The sample group of images may include faces from a diverse group of individuals instead of only from individuals who are, for example, older than sixty. In some implementations, the face detector 108 may perform facial detection with eighty percent accuracy on a sample group of images that only includes individuals who are older than sixty using the default facial detection parameters. In this instance, it may be advantageous to adjust the facial detection parameters if the system 100 is able to access information that any subject of the image is likely to be older than sixty.

In some implementations, the system 100 may access an identification document 104 for the individual in the image 110. The system 100 may use a document scanner 116 that is configured to scan documents. The document scanner 116 may scan the identification document 104 that is an identification document for the user 102. The identification document 104 may be a driver's license, a passport, or a similar identification document. The identification document 104 may be used to back up identity assertions of document holders. The identification document 104 may also be used to verify ages, prove driving privileges, access a secure area, cash a check, and so on.

In some instances, identification documents often become the target for counterfeiting and fraud. To deter such deleterious acts, security features can be embedded into identification documents. The security features on the identification documents can provide authorities and card holders with a sense of security to preserve, for example, the trust in the asserted identity. Large number of transactions may rely on the authenticity of these underlying identification documents. As such, the security features on the identification documents can become paramount to support an identification document as a genuine and up-to-date identity proof.

Unlike currencies that are also in wide use by the populace, identification documents are unique to the particular document holder. Therefore, the security features on identification documents can incorporate personalization element to attest to ownership and further heighten the difficulty for counterfeiting and fakery. Implementations disclosed herein incorporate laser-engraved security features underneath the surface of an identification document. Some implementations may embed personally identifiable information in the laser-engraved features. Some implementations may provide biometric representations in the laser engraved features. In some instances, the personally identifiable information or the biometric representation can be embedded into a metalized holographic image underneath the surface of the identification document.

Identification documents are broadly defined to include, for example, credit cards, bank cards, phone cards, passports, driver's licenses, network access cards, employee badges, debit cards, security cards, visas, immigration documentation, national ID cards, citizenship cards, permanent resident cards (e.g., green cards), Medicare cards, Medicaid cards, social security cards, security badges, certificates, identification cards or documents, voter registration cards, police ID cards, border crossing cards, legal instruments, security clearance badges and cards, gun permits, gift certificates or cards, membership cards or badges, etc., etc. Also, the terms “document,” “card,” “badge,” and “documentation” are used interchangeably throughout this patent application.

Many types of identification cards and documents, such as driving licenses, national or government identification cards, bank cards, credit cards, controlled access cards and smart cards, carry thereon certain items of information which relate to the identity of the bearer. Examples of such information include name, address, birth date, signature and photographic image. The cards or documents may in addition carry other variant data (e.g., data specific to a particular card or document, for example an employee number) and invariant data (e.g., data common to a large number of cards, for example the name of an employer). All of the cards described above will hereinafter be generically referred to as identification documents.

A portion of the identification document 104 may include personally identifiable information such as the name, residential address, and date of birth of the card holder. “Personalization”, “Personalized data” and “variable” data are used interchangeably herein, and refer at least to data, characters, symbols, codes, graphics, images, and other information or marking, whether human readable or machine readable, that is (or can be) “personal to” or “specific to” a specific cardholder or group of cardholders. Personalized data can include data that is unique to a specific cardholder (such as biometric information, image information, serial numbers, Social Security Numbers, privileges a cardholder may have, etc.), but is not limited to unique data. Personalized data can include some data, such as birthdate, height, weight, eye color, address, etc., that are personal to a specific cardholder but not necessarily unique to that cardholder (for example, other cardholders might share the same personal data, such as birthdate). In at least some implementations, personal/variable data can include some fixed data, as well.

The personally identifiable information may additionally include, for example, a biometric representation of the card holder, for example, name of card holder, residential address information, gender information, biometric information such as height, weight, eye color, and hair color.

The OCR module 118 may be configured to identify and extract the personally identifiable information from the scan of the identification document 118. The OCR module 118 may be configured to handle security features such as holograms that may include or cover a portion of the personally identifiable information. For example, the date of birth of the user 102 may include a background of a hologram. The OCR module 118 may be configured to identify the date of birth despite the background that may cause the text of the date of birth difficult to identify.

In some implementations, the OCR module 118 may be configured to identify the image of the user 102. For example, the identification document 104 may include text that the OCR module 118 identifies and outputs. The OCR module 118 may also be configured to identify a portion of the identification document 104 that includes an image of the user 102. The OCR module 118 may output the image along with the identified text.

The document data identifier 120 may receive the identified text and any extracted image from the OCR module 118. The document data identifier 120 may be configured to interpret and determine what the identified text represents. The document data identifier 120 may be configured to tokenize the identified text and determine that some of the identified text include labels for different fields and the values for those fields. For example, the OCR module 118 may identify the text “sex: male” on a the identification document 104. The document data identifier 120 may determine that “sex” is a field and “male” is the value for that field. The document data identifier 120 may determine that the gender of the user 102 is male. The document data identifier 120 may be able to determine that other portions of the identified text represent values for fields that may not be labeled on the identification document 104. For example, the OCR module 118 may identify the text “100 Elm St” on a the identification document 104. While the identified text may not include text that expressly identifies the address field, the document data identifier 120 may be configured to determine that the text “100 Elm St” is part of the address field.

In some implementations, the document data identifier 120 may be configured to identify additional characteristics of the user 102 that may be likely based on the data identified from the identification document 104. For example, the document data identifier 120 may determine the age of the user 102 based on the birthdate on the identification document 104. The document data identifier 120 may use the age of the user 102 in combination with the address of the user 102 to determine a likely income range for the user 102. The demographic data storage 122 may include some demographic information that the document data identifier 120 and compare against to determine likely characteristics of the user 102, including demographic characteristics. For example, the demographic data storage 122 may include average incomes for people of different ages in different zip codes.

In some implementations, the document data identifier 120 may be able to identify demographic information about the user 102 by analyzing the image of the user 102 extracted from the identification document 104. For example, the document data identifier 120 may be able to identify a race, hair color, or other information about the user 102 in cases where that information may not be written on the identification document 104.

In some implementations, the document data identifier 120 may be configured to extract information that may be encoded on the identification document 104. For example, the identification document 104 may include a barcode. The OCR module may identify the portion of the identification document 104 that includes the barcode and provide the barcode to the document data identifier 120. The document data identifier 120 may be configured to extract information encoded in the barcode. The barcode may encode the name of the user 104, the address of the user 104, and any other information included on the identification document 104. The document data identifier 120 may use the extracted information to compare to any information identified from analyzing the text on the identification document 104.

The image capture parameters adjuster 124 may receive the data extracted from the identification document 104 and data identified by the document data identifier 120. For example, the image capture parameters adjuster 124 may receive the date of birth of the user 102, the height of the user 102, the eye color of the user 102, hair color of the user 102, the gender of the user 102, likely income of the user 102, and any other similar information extracted from the identification document 104. The image capture parameters adjuster 124 may be configured to adjust the image capture parameters 114 based on the identified demographic data of the user 102. The image capture parameters adjuster 124 may adjust the image capture parameters such as brightness and saturation to ensure a properly exposed image for a user with dark hair. As another example, the image capture parameters adjuster 124 may adjust the flash and/or exposure of the camera 112 in instances where the user 102 likely wears glasses. This may be the case if the user is over fifty years old and/or the information on the identification document 104 indicates that the user 102 wears corrective lenses.

The facial detection parameters adjuster 126 may also receive the data extracted from the from the identification document 104 and data identified by the document data identifier 120. For example, the facial detection parameters adjuster 126 may receive the eye color of the user 102 and the hair color of the user 102. The facial detection parameters adjuster 126 may adjust a facial detection parameters related to edge detection. In instances where the user 102 has light hair, the facial detection parameters adjuster 126 may adjust an edge detection parameter to be more sensitive smaller color gradients. In instances where the user 102 likely wears glasses, the facial detection parameters adjuster 126 may adjust a parameter related to detecting eyes in the presence of reflections that may occur on the glasses of the user 102.

The face detector 108 performs facial detection with the facial detection parameters 106 as adjusted by the facial detection parameter adjuster 126. If the face detector 108 is able to determine that the image 110 include a face, then the face detector may mark the face with an outline. In some implementations, the face detector 108 may be configured to determine whether the image quality of the face is high enough for the image 110 to be used for an application or for an enrollment purpose. For example, the user 102 may be attempting to capture the image 110 for use with a driver's license renewal. The face detector 108 may be configured to determine whether the image 110 includes a face and additionally determine whether the face image is of sufficient quality for the driver's license renewal. The face detector 108 may use the facial detection parameters 106 to perform the facial detection, and the adjusted parameters may allow the face detector 108 to perform facial detection using less processing power than the face detector 108 using the default parameters.

In some implementations, the face detector 108 may determine that the image 110 does not include a face or may determine that the face included in the image 110 is not of sufficient quality for the current application. In this instance, the face detector 108 may provide an indication to the user 102 to move some distance in relation to the camera 112. The face detector 108 may provide an indication to the user 102 to adjust the ambient lighting in the area where the user 102 is located.

In some implementations, the face detector 108 may provide an instruction to the image capture parameters adjuster 124 to adjust the image capture parameters 114. For example, the face detector 108 may instruct the image capture parameters adjuster 124 to adjust the expose of any subsequent images captured by the camera 112. The image capture parameters adjuster 124 may continue to adjust the image capture parameters 114 for each subsequent image until the face detector 108 indicates that the image include a face and/or the image is of sufficient quality.

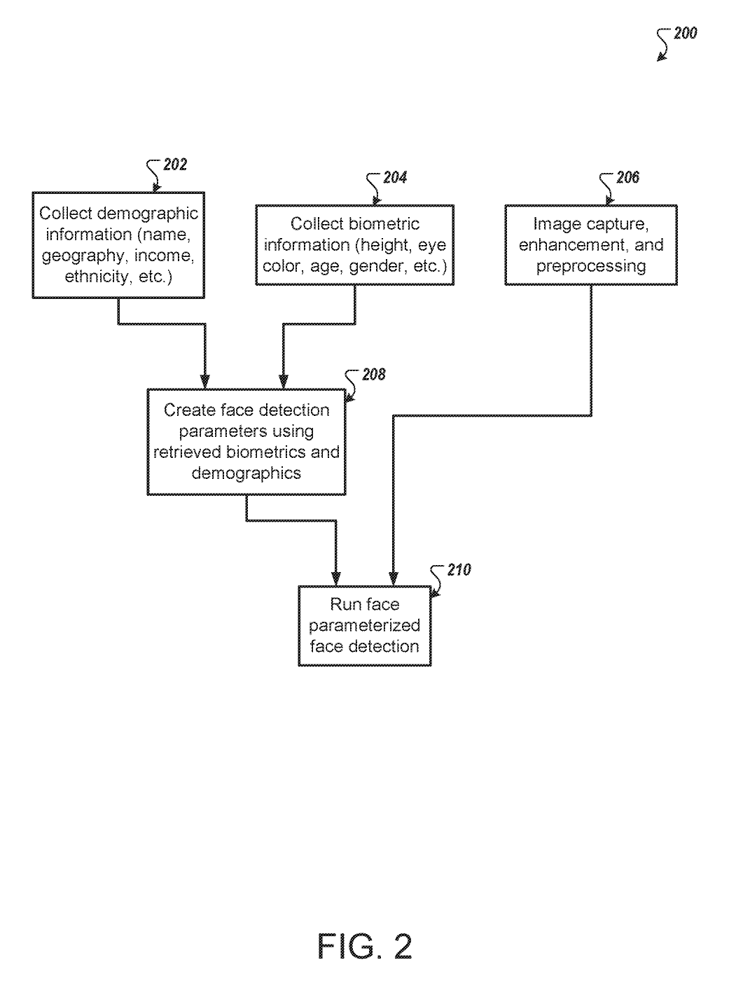

FIG. 2 is a diagram 200 showing an example of combining demographic data and biometric data. The process may be applicable at a registration site when people are signing up for entry into a system. The registration site may vet people for services such as voter registration or enrollment in class. Initially, an input of demographic information may be collected (202). The demographic information may include family name indication, first name indication, geography, income, ethnicity, etc. In some implementations, the demographic information may be obtained from an identification document of the subject via optical character recognition (OCR). Examples of identification documents include a passport, a driver's license, a student identification card, or a membership card. As the demographic information may be embedded in barcodes, watermarks, or machine readable zones, some implementations may involve scanning bar codes, watermarks, or machine readable zones to extract relevant demographic information. In some implementations, the demographic information may be obtained from a textual document such as a registration form.

Another input of biometric information may also be collected (204). Such biometric information may be specific to the person seeking registration. Examples of biometric information include: gender, hair color, eye color, height, weight, eye color, etc. In some implementations, the biometric information may be obtained from an identification document of the subject via optical character recognition (OCR). Examples of identification documents include a passport, a driver's license, a student identification card, or a membership card. As the biometric information may be embedded in barcodes, watermarks, or machine readable zones, some implementations may involve scanning bar codes, watermarks, or machine readable zones to extract relevant biometric information. In some implementations, the biometric information may be obtained from a textual document such as a registration form.

Some implementations may incorporate an image capture, enhancement, and processing unit configured to acquire a biometric image of the subject (206). Examples of biometric image can include a facial portrait or a fingerprint. The biometric image may be obtained as part of the registration process to verify a subject seeking entry into a system so that the subject's information is scrutinized before it enters into a database system. The image capture, enhancement, and processing unit may generally include a digital camera unit with processor core(s) suited for digital image processing. The image capture, enhancement, and processing unit may also include a fingerprint slap scanner device, or a data storage device. The scanner device may include an optical fingerprint imaging device for capturing a digital image of the print using visible light. The scanner device and the digital camera device can include an array of solid state pixels (e.g., a charge-coupled device (CCD)) which captures an optical image of the fingerprint.

In some implementations, biometric detection parameters may be created using retrieved biometric data and demographic data (208). For example, facial detection hints may be generated based on hints that are synthesized based on the combination of demographic data and biometric data. In one illustration, the demographic information such as ethnicity can reveal that the subject is more likely to be dark-skinned or light-skinned. Because this difference can lead to different lighting and exposure parameters for acquiring a camera image, such hints can be leveraged to fine tune camera acquisition parameters. In a similar vein, based on the biometric data, the subject can be inferred to be in an age group who is more likely to have corrective eyewear or a particular hair color. Likewise, height and weight combination may be used to infer a particular face shape such as chubby. Additionally, female first name can be used to indicate an increased likelihood for longer hair style or other personal traits on a facial portrait. Intensity normalization may then be performed on fingerprint slap scan image.

The face detection parameters may then be used to run face parameterized face detection (210). When the face parameters indicate that a darker facial complexion is more likely, the facial image may be obtained with camera settings to match the dynamic range of contrast more suitable for acquiring such features. When the face parameter hint at a more likely chubby appearance or a more likely presence of gray hair, the acquired facial portrait can be compared with a template with such features; and if such features are missing, an alert may be generated. An operator may further inspect to determine if there has been an erroneous acquisition of demographic/biometric data or the biometric image. In some implementations, biometric images can be preprocessed and enhanced when features such as eyewear is present, which can give rise to optical reflections. Image processing modules may then be invoked to compensate or correct such appearances. Some implementations may be based on salient features that are more likely present. Some implementations may factor in distinct features that are more likely absent. In both situations, hints of this nature can be acted upon so that the image acquisition process is executed more intelligently than otherwise would be the case.

Thus, in many applications using face detection, demographic and biometric data may be available prior to face detection. The demographic data and the biometric data can be combined to generate face acquisition parameters that provide suggestive hints at specific features that are more or less likely present. The intelligence may be obtained through supervised learning process to render the inference engine more and more fined tuned after each iteration. In this manner, face detection processes can exploit such hints and clues to improve the likelihood of successful enrollment.

Implementations of the disclosure can reduce the likelihood of errors during enrollment when biometric and demographic data do not suggest features present in or absent from the acquired biometric image. Implementations can improve biometric image production quality assurance so that inconsistent or inferior image acquisitions can be singled out for corrections or re-acquisition. Implementations can also improve accuracy of automated reading of identity documents when demographic and biometric data from the identity documents are relied upon to verify subjects for enrollment/registration. Inaccurate information automatically read can be caught by the operator upon additional inspection when the synthesized hints do not agree with the biometric image taken on-site. Implementations can provide hints for faster and more efficient reading of identity documents when demographic and biometric data support biometric image taken on-site so that manual inspection can be by-passed.

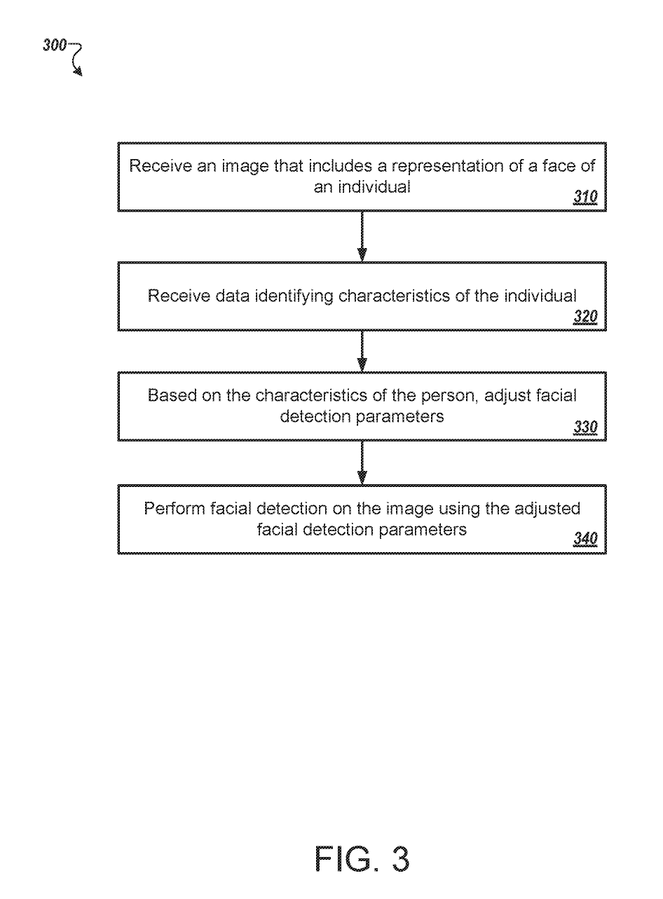

FIG. 3 is a flowchart of an example process 300 for using identity information to improve facial detection. In general, the process 300 identifies demographic data related to a subject of an image. The process 300 infers likely characteristics of the subject based on the demographic data. Based on the inferred characteristics, the process 300 adjust image capture parameters and facial detection parameters. The process 300 may use the image capture parameters to capture an image and the facial detection parameters to perform facial detection on the captured image. The process 300 will be described as being performed by a computer system comprising one or more computers, for example, the system 100 of FIG. 1. Each of the components of system 100 may be included on a single computing device or distributed across multiple computing devices.

The system receives an image that includes a representation of a face of an individual (310). In some implementations, the system may receive an indication from a user that the image includes a representation of the face of the individual, or user. In some implementations, the system may not receive any indication that the image includes a face.

The system receives data identifying characteristics of the individual (320). In some implementations, the system receives an image of an identification document of the user. The system performs optical character recognition on the identification document. The system may determine the characteristics of the individual based on the information extracted from the identification document. For example, the system may extract the height and weight of the individual. Based on the extracted data, the system may infer additional characteristics of the individual. For example, based on the weight of the user being two hundred fifty pounds and the height being five feet ten inches, the system may infer that the user has a wider than average face.

The system, based on the characteristics of the person, adjusts facial detection parameters (330). The system may use a default setting for the facial detection parameters to perform facial detection. The system may adjust the facial detection parameters based on the inferred characteristics of the individual. For example, if the system determines that the individual likely has a wider than average face, then the system may adjust the facial detection parameters related to detecting edges of a person's face. If the system determines that the individual likely wears glasses, then the system may adjust a facial detection parameter related to eye detection to account for the increased likelihood that there may be reflections around the eyes.

The system performs facial detection on the image using the adjusted facial detection parameters (340). In some implementations, the system indicates to the individual that the system detected a face in the image. In some instances, the system may indicate that the system did not detect a face in the image. In this case and in other instances, the system may adjust image capture parameters of the camera and capture an additional image. The image capture parameters may be related to the lighting of the environment of the individual. For example, the image capture parameters may be related to the flash and/or other lighting. The system may perform facial detection on the image captured with the adjusted image capture parameters.

In some implementations, the system may use the image for an application and/or enrollment purposes. For example, the individual may be attempting to renew the individual's driver's license using the system instead of physically traveling to a driver's license office. In this instance, the system may analyze the image to determine whether the quality is sufficient for the purposes of the application and/or enrollment purpose. The system may determine a value that reflects the quality of the representation of the face to a threshold value for a system receiving the image. The system may compare that value to a threshold value for the system. If the value satisfies the threshold value, then the image is acceptable for the application. If the value does not satisfy the threshold value, then the image is not acceptable and the system may capture an additional image of the user using different image capture parameters.

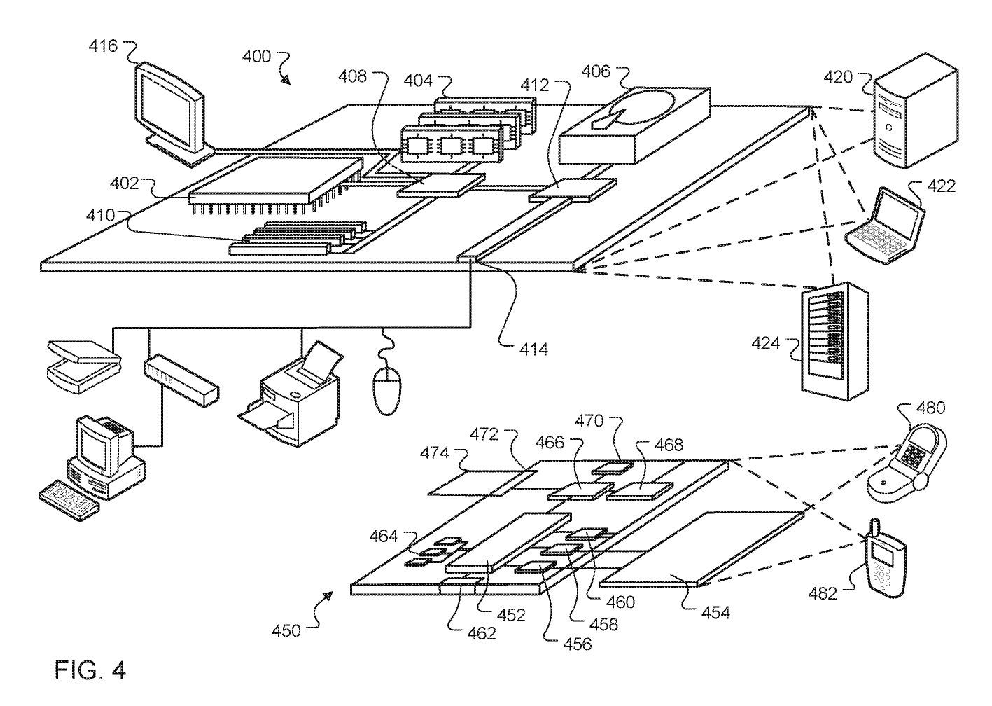

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
receiving, by one or more computers, an image that includes a representation of a face of an individual;
receiving, by the one or more computers, data identifying characteristics of the individual;
based on the characteristics of the person, adjusting, by the one or more computers, facial detection parameters; and
performing, by the one or more computers, facial detection on the image using the adjusted facial detection parameters.

2. The method of claim 1, comprising:
based on the characteristics of the person, adjusting, by the one or more computers, the image,
wherein performing facial detection on the image using the adjusted facial detection parameters comprises performing facial detection on the adjusted image using the adjusted facial detection parameters.

3. The method of claim 1, wherein receiving data identifying characteristics of the individual comprises:
receiving demographic data of the individual; and
receiving biometric data of the individual.

4. The method of claim 1, wherein:
adjusting facial detection parameters comprises identifying likely facial characteristics of the individual based on the characteristics of the person.

5. The method of claim 1, comprising:
based on the characteristics of the person, adjusting, by the one or more computers, parameters of a camera that captured the image;
receiving, by the one or more computers, an additional image that includes an additional representation of the face of the individual and that was captured by the camera with the adjusted parameters; and
performing, by the one or more computers, facial detection on the additional image using the adjusted facial detection parameters.

6. The method of claim 1, comprising:
based on performing facial detection on the image, determining, by the one or more computers, that the image includes a representation of a face;
determining, by the one or more computers, a value that reflects a quality of the representation of the face;
comparing, by the one or more computers, the value that reflects the quality of the representation of the face to a threshold value for a system receiving the image;
determining, by the one or more computers, that the value that reflects the quality of the representation of the face satisfies the threshold value for the system receiving the image; and
based on determining that the value that reflects the quality of the representation of the face satisfies the threshold value for the system receiving the image, providing, by the one or more computer, the image to the system.

7. The method of claim 1, wherein receiving data identifying characteristics of the individual comprises:
performing optical character recognition on a personal identification document of the individual.

8. A system comprising:
one or more computers; and
one or more storage devices storing instructions that are operable, when executed by the one or more computers, to cause the one or more computers to perform operations comprising:
receiving, by one or more computers, an image that includes a representation of a face of an individual;
receiving, by the one or more computers, data identifying characteristics of the individual;
based on the characteristics of the person, adjusting, by the one or more computers, facial detection parameters; and
performing, by the one or more computers, facial detection on the image using the adjusted facial detection parameters.

9. The system of claim 8, wherein the operations comprise:
based on the characteristics of the person, adjusting, by the one or more computers, the image,
wherein performing facial detection on the image using the adjusted facial detection parameters comprises performing facial detection on the adjusted image using the adjusted facial detection parameters.

10. The system of claim 8, wherein receiving data identifying characteristics of the individual comprises:
receiving demographic data of the individual; and
receiving biometric data of the individual.

11. The system of claim 8, wherein:
adjusting facial detection parameters comprises identifying likely facial characteristics of the individual based on the characteristics of the person.

12. The system of claim 8, wherein the operations comprise:
based on the characteristics of the person, adjusting, by the one or more computers, parameters of a camera that captured the image;
receiving, by the one or more computers, an additional image that includes an additional representation of the face of the individual and that was captured by the camera with the adjusted parameters; and
performing, by the one or more computers, facial detection on the additional image using the adjusted facial detection parameters.

13. The system of claim 8, wherein the operations comprise:
based on performing facial detection on the image, determining, by the one or more computers, that the image includes a representation of a face;
determining, by the one or more computers, a value that reflects a quality of the representation of the face;
comparing, by the one or more computers, the value that reflects the quality of the representation of the face to a threshold value for a system receiving the image;
determining, by the one or more computers, that the value that reflects the quality of the representation of the face satisfies the threshold value for the system receiving the image; and
based on determining that the value that reflects the quality of the representation of the face satisfies the threshold value for the system receiving the image, providing, by the one or more computer, the image to the system.

14. The system of claim 8, wherein receiving data identifying characteristics of the individual comprises:
performing optical character recognition on a personal identification document of the individual.

15. A non-transitory computer-readable medium storing software comprising instructions executable by one or more computers which, upon such execution, cause the one or more computers to perform operations comprising:
receiving, by one or more computers, an image that includes a representation of a face of an individual;
receiving, by the one or more computers, data identifying characteristics of the individual;
based on the characteristics of the person, adjusting, by the one or more computers, facial detection parameters; and
performing, by the one or more computers, facial detection on the image using the adjusted facial detection parameters.

16. The medium of claim 15, wherein the operations comprise:
based on the characteristics of the person, adjusting, by the one or more computers, the image,
wherein performing facial detection on the image using the adjusted facial detection parameters comprises performing facial detection on the adjusted image using the adjusted facial detection parameters.

17. The medium of claim 15, wherein receiving data identifying characteristics of the individual comprises:
receiving demographic data of the individual; and
receiving biometric data of the individual.

18. The medium of claim 15, wherein:
adjusting facial detection parameters comprises identifying likely facial characteristics of the individual based on the characteristics of the person.

19. The medium of claim 15, wherein the operations comprise:
based on the characteristics of the person, adjusting, by the one or more computers, parameters of a camera that captured the image;
receiving, by the one or more computers, an additional image that includes an additional representation of the face of the individual and that was captured by the camera with the adjusted parameters; and
performing, by the one or more computers, facial detection on the additional image using the adjusted facial detection parameters.

20. The medium of claim 15, wherein the operations comprise:
based on performing facial detection on the image, determining, by the one or more computers, that the image includes a representation of a face;
determining, by the one or more computers, a value that reflects a quality of the representation of the face;
comparing, by the one or more computers, the value that reflects the quality of the representation of the face to a threshold value for a system receiving the image;
determining, by the one or more computers, that the value that reflects the quality of the representation of the face satisfies the threshold value for the system receiving the image; and
based on determining that the value that reflects the quality of the representation of the face satisfies the threshold value for the system receiving the image, providing, by the one or more computer, the image to the system.
